(19) United States
(12) Patent Application Publication
(10) Pub. No.: US 2015/0271582 A1
(43) Pub. Date: Sep. 24, 2015

(54) WIRELESS BOTTLE CAP SPEAKER

(71) Applicant: DEXIN CORPORATION, New Taipei City (TW)

(72) Inventor: WANG-DONG CHENG, NEW TAIPEI CITY (TW)

(73) Assignee: DEXIN CORPORATION, New Taipei City (TW)

(21) Appl. No.: 14/292,934

(22) Filed: Jun. 1, 2014

(30) Foreign Application Priority Data
Mar. 24, 2014 (TW) 103204982

(51) Int. Cl. H04R 1/02; H04R 1/04

(52) U.S. Cl. CPC H04R 1/028; H04R 1/021; H04R 1/025; H04R 1/04; H04R 2420/07

(57) ABSTRACT

A wireless bottle cap speaker adapted for a bottle includes a cap body, a speaker, and a playback control module. The cap body has a lower portion for detachably connecting to an upper portion of the bottle. The speaker is disposed in the cap body. The playback control module is disposed in the cap body and electrically coupled to the speaker. In addition, the playback control module includes a processing unit and a wireless communication unit coupled to the processing unit. The wireless communication unit is capable of wirelessly receiving signals from a mobile device. The processing unit is for operating the speaker according to the signals received from the wireless communication unit.

### BACKGROUND OF THE DISCLOSURE

1. Field of the Disclosure

The instant disclosure relates to a cap; in particular, to a wireless bottle cap speaker adapted for a bottle.

2. Description of Related Art

Nowadays, almost all portable speakers are not combined with outdoor or sport products. Therefore, a user must hang the portable speaker on a hook to carry it while taking outdoor exercise.

However, carrying the conventional portable speaker brings the certain disadvantage of increasing carrying space and burden to the user. Consequently, the user cannot easily enjoy listening to music while taking outdoor exercise.

To address the above issues, the inventor has striven via associated experience and research and presents the instant disclosure, which can effectively improve the limitation described above.

### SUMMARY OF THE DISCLOSURE

The instant disclosure provides a wireless bottle cap speaker. The wireless bottle cap speaker is for a user having the habit of carrying a sport bottle out while taking outdoor exercise. The wireless bottle cap speaker can be easily detachably combined with the sport bottle without increasing carrying space and burden to the user, so that the user can easily enjoy listening to music played aloud while taking outdoor exercise.

According to one exemplary embodiment of the instant disclosure, the wireless bottle cap speaker adapted for a bottle includes a cap body, a speaker, and a playback control module. The cap body has a lower portion for detachably connecting to an upper portion of the bottle. The speaker is disposed in the cap body. The playback control module is disposed in the cap body and electrically coupled to the speaker. The playback control module also includes a processing unit and a wireless communication unit coupled to the processing unit. The wireless communication unit is capable of wirelessly receiving input signals from a mobile device. The processing unit is for operating the speaker according to the input signals received from the wireless communication unit.

In summary, the lower portion of the cap body can be easily detachably connected to the upper portion of the bottle. And, the wireless communication unit is capable of wirelessly receiving input signals from the mobile device, so that the processing unit can operate the speaker to play or stop playing music according to the input signals received from the wireless communication unit. Thus, the wireless bottle cap speaker provides the user with a convenient device for listening to music aloud without using headphones and increasing burden while taking outdoor exercise.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1 shows an isometric view of a wireless bottle cap speaker with a bottle of the instant disclosure.

FIG. 2 shows an exploded view of a wireless bottle cap speaker with a bottle of the instant disclosure.

FIG. 3 shows another exploded view of a wireless bottle cap speaker with a bottle of the instant disclosure.

FIG. 4 shows a cross sectional view of a wireless bottle cap speaker with a bottle of the instant disclosure.

FIG. 5 shows a usage of a wireless bottle cap speaker connected to a bottle according to an embodiment of the instant disclosure.

FIG. 6 shows another usage of a wireless bottle cap speaker connected to a bottle according to an embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below and an element could be termed a second element, component, region, layer or section without departing from the teachings of the instant disclosure. As used herein, the term “and/or” includes any and all combinations of one or more of the associated listed items.

It is understood that when an element is described as “connected” or “coupled” to another element, the element may be directly connected to or directly coupled to another element, or there is an inserted element. On the contrary, when an element is “directly connected to” or “directly coupled to” another element, then there is no inserted element. This is also to be understood in a similar way when describing the relation between elements using other descriptive terms such as “between” versus “directly between” and “adjacent” versus “directly adjacent.”

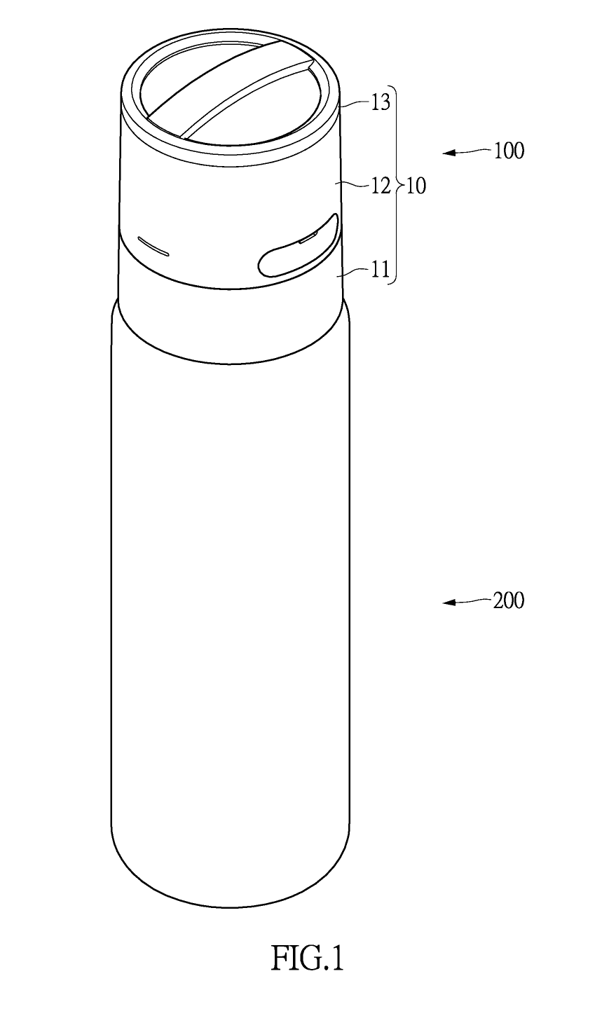

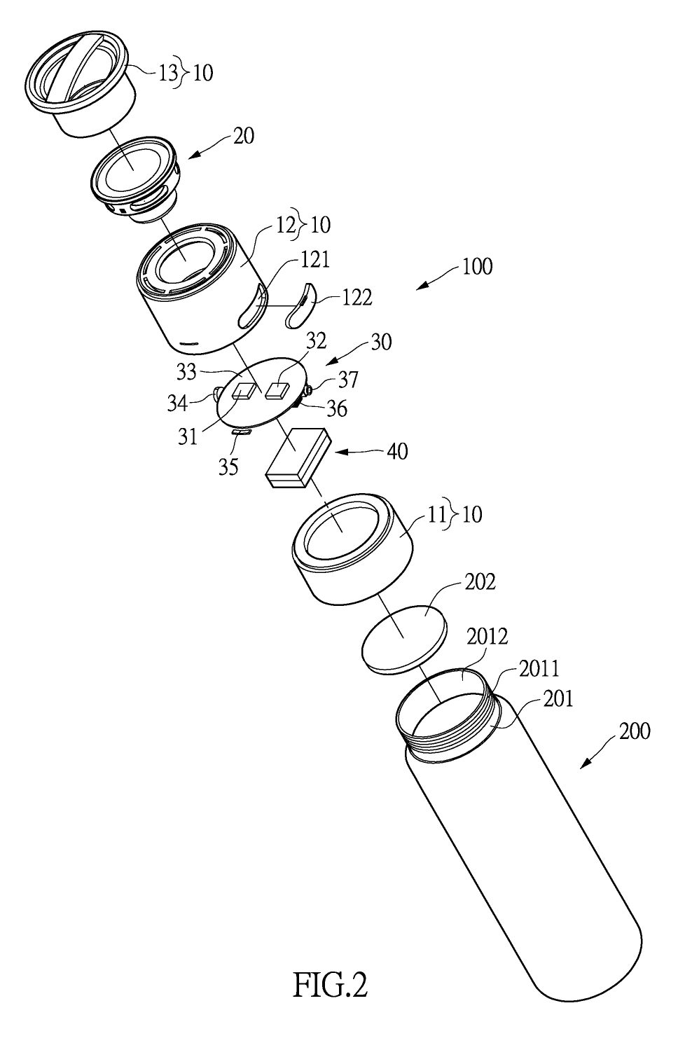

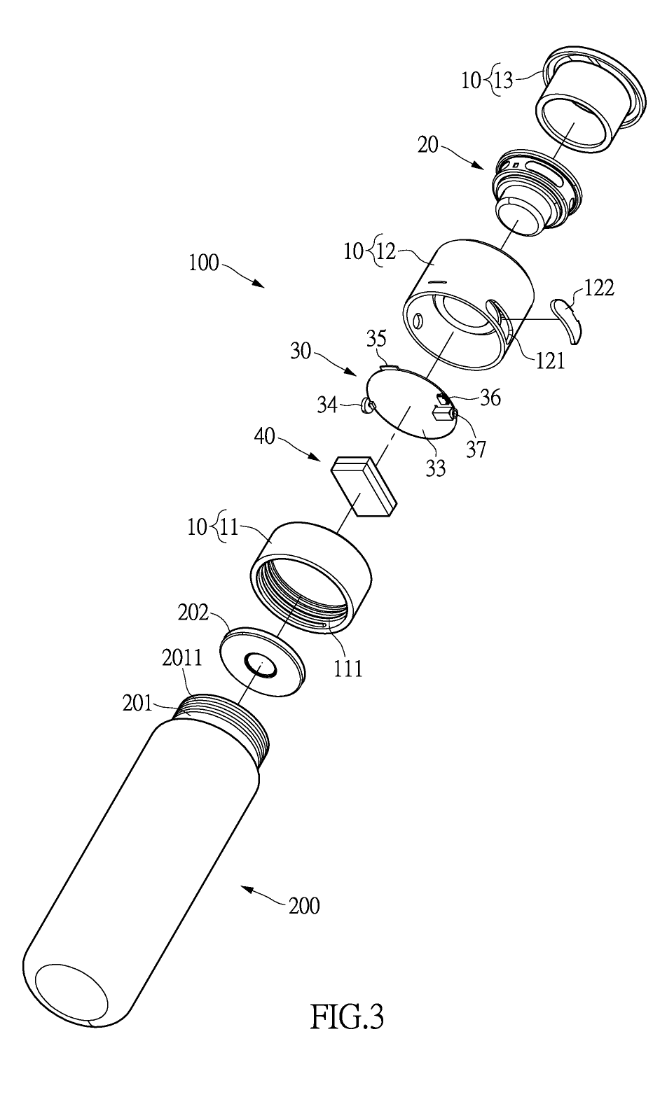

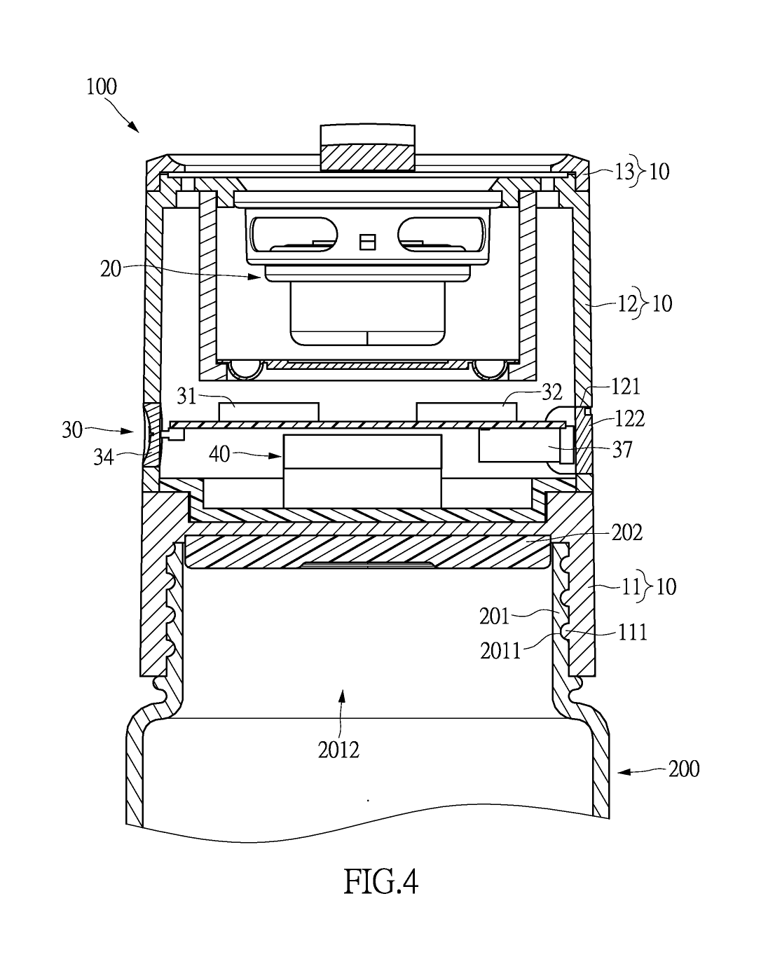

As shown in FIG. 1, a wireless bottle cap speaker 100 is adapted for a bottle 200, and the bottle 200 may be a sport bottle, a PET bottle, or a vacuum bottle. Please refer to FIGS. 2 to 4. The wireless bottle cap speaker 100 mainly comprises a cap body 10, a speaker 20, and a playback control module 30.

The cap body 10 can be a waterproof cap body having a lower portion 11, an upper portion 13, and a main portion 12 there-between. The lower portion 11 of the cap body 10 is for detachably connecting to an upper portion 201 of the bottle 200.

Specifically, the lower portion 11 of the cap body 10 has a first connector 111. The upper portion 201 of the bottle 200 has a second connector 2011. The first connector 111 is arranged for detachable connection with the second connector 2011.

More specifically, the first connector 111 can be a female threaded connector with internal threads, and the second connector 2011 can be a male threaded connector with external threads, so that the wireless bottle cap speaker 100 can be screwed onto the bottle 200.

In one embodiment of the instant discourse, the first connector 111 can be a male threaded connector with external threads, and the second connector 2011 can be a female threaded connector with internal threads.

In another embodiment of the instant discourse, the first connector 111 can be a female connector without internal threads, and the second connector 2011 can be a male connector without external threads. The first connector 111 is arranged for detachably connecting with the second connector 2011 in a tight fit manner.

Moreover, the upper portion 201 of bottle 200 has an opening 2012 inwardly formed thereon. When the lower portion 11 of the cap body 10 is detachably secured to the upper portion 201 of the bottle 200, the lower portion 11 of the cap body 10 can cover the opening 2012. The bottle 200 may have a seal cover 202 detachably covering the opening 2012 to ensure that liquid will not spill from the bottle 200.

The speaker 20 is disposed in the main portion 12 and near the upper portion 13 of the cap body 10. The speaker 20 is used to play music aloud. The speaker 20 can be a mono speaker or a stereo speaker.

The playback control module 30 is electrically coupled to the speaker 20. The playback control module 30 can be electrically connected to the speaker 20 via conductive wires (not shown).

Specifically, the playback control module 30 includes a processing unit 31 and a wireless communication unit 32 coupled to the processing unit 31. In addition, the playback control module 30 can further include a substrate 33 for the processing unit 31 and the wireless communication unit 32 disposed upon.

The processing unit 31 can be a microcontroller unit, or a system on chip. The wireless communication unit 32 can be a Bluetooth unit, a Wi-Fi unit, a Zigbee unit, a near field communication (NFC) unit, a radio frequency (RF) unit, or combinations thereof.

The wireless communication unit 32 is used to establish communication with a mobile device such as a smart phone, a smart watch and so forth. In addition, the wireless communication unit 32 is capable of wirelessly receiving signals from the mobile device, and the processing unit 31 is for operating the speaker 20 according to the signals received from the wireless communication unit 32. The mobile device may have an installed application. By launching the installed application, the mobile device can establish communication with the wireless bottle cap speaker 100. The mobile device can start wirelessly transmitting signals to the wireless bottle cap speaker 100 when the mobile device and the wireless bottle cap speaker 100 have established communication with each other. The mobile device may transmit audio signals or control signals. The wireless bottle cap speaker 100 can play music aloud when the mobile device is transmitting audio signals. The wireless bottle cap speaker 100 can stop playing music or switch songs when the mobile device is transmitting control signals.

The playback control module 30 further includes an operation unit 34 electrically coupled to the processing unit 31, and exposed at the surface of the main portion 12 of the cap body 10. The operation unit 34 is used for generating a key signal to the processing unit 31. The operation unit 34 can be a push button, a roller, a slide switch or an electronic switch or combinations thereof. The processing unit 31 is also for operating the speaker 20 according to the key signal generated from the operation unit 34. When the operation unit 34 is generating a key signal to the processing unit 31, the processing unit 31 can operate the speaker 20 to play music aloud or stop playing music.

The playback control module 30 further includes a display unit 35 electrically coupled to the processing unit 31, and exposed at the surface of the main portion 12 of the cap body 10. The display unit 35 is used for displaying the status such as, connection status, music play status, and power status detected by the processing unit 31. The display unit 35 can be an LED indicator or a display screen.

To provide the option of using cable connection for the wireless bottle cap speaker 100, the playback control module 30 can further include a connection port 36 and an audio port 37 electrically coupled to the processing unit 31 separately. The connection port 36 and an audio port 37 can be disposed on the substrate 33. In addition, a side of the main portion 12 of the cap body 10 has a side opening 121 formed thereon, the connection port 36 and the audio port 37 are exposed through the side opening 121. In addition, the main portion 12 of the cap body 10 has a side cover 122 for covering the side opening 121. The shape of the side cover 122 is corresponding to the shape of the side opening 121. The connection port 36 can be a universal serial bus (USB, Mini USB, and Micro USB) port, and the audio port 37 can be a 2.5 mm or 3.5 mm standard headphone jack.

In another embodiment of the instant discourse, the connection port 36 can be a memory card port that utilizes a memory card (not shown) for storing songs.

The wireless bottle cap speaker 100 may have a power module 40 electrically coupled to the playback control module 30 and the speaker 20. The power module 40 is disposed in the main portion 12 of the cap body 10, and between the playback control module 30 and the lower portion 11 of the cap body 10. The power module 40 is used to provide the needed power for the wireless bottle cap speaker 100. The power module 40 may be a replaceable battery or a rechargeable battery. The power module 40 can be recharged via the connection port 36 to an external power source. For power saving, the processing unit 31 can activate power saving mode when a user does not need to use the wireless bottle cap speaker 100.

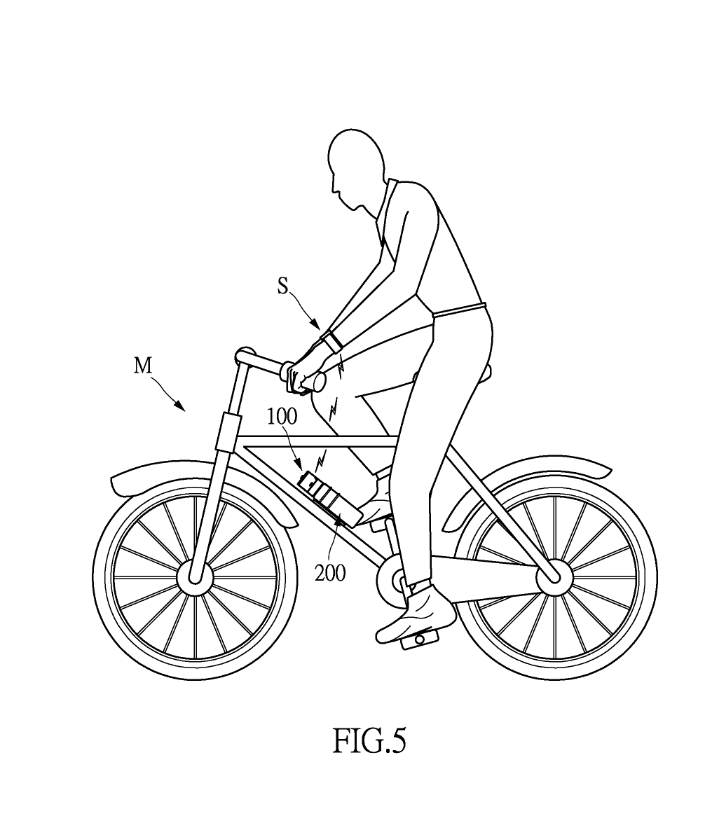

Please refer to FIG. 5, FIG. 5 shows a usage of a wireless bottle cap speaker connected to a bottle according to an embodiment of the instant disclosure. In use, the wireless bottle cap speaker 100 is connected to the bottle 200 and both are mounted on a water bottle holder of a bike M, and a mobile device S such as a smart watch is worn on a user's wrist. After the mobile device S and the wireless bottle cap speaker 100 have established communication with each other, the mobile device S can start transmitting audio signals or control signals to the wireless bottle cap speaker 100 that allows the user to enjoy listening to music while riding the bike M without using headphones. Moreover, the wireless bottle cap speaker 100 screwed onto the bottle 200 are both mounted on the water bottle holder of the bike M and so will not increase the carrying space and burden to the user.

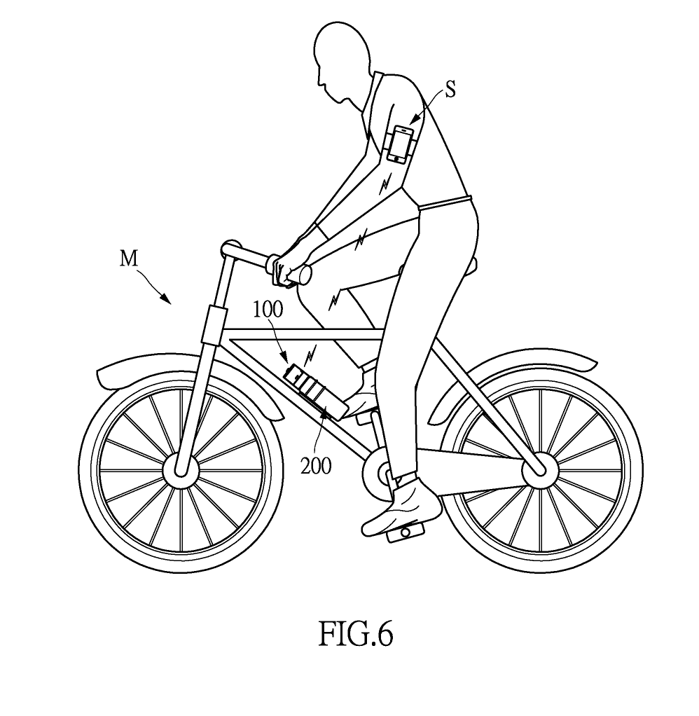

Please refer to FIG. 6, FIG. 6 shows another usage of a wireless bottle cap speaker connected to a bottle according to an embodiment of the instant disclosure. In use, the wireless bottle cap speaker 100 is connected to the bottle 200 and both are mounted on the water bottle holder of the bike M, and a mobile device S such as a smart phone is worn on a user's arm. Similar to before, the user is able to ride the bike and enjoy listening to music played aloud.

The descriptions illustrated supra set forth simply the preferred embodiments of the instant disclosure; however, the characteristics of the instant disclosure are by no means restricted thereto. All changes, alterations, or modifications considered by those skilled in the art are deemed to be encompassed within the scope of the instant disclosure delineated by the following claims.

What is claimed is:

1. A wireless bottle cap speaker, adapted for a bottle, comprising:
a cap body, having a lower portion for detachably connecting to a upper portion of the bottle;
a speaker disposed in the cap body; and
a playback control module disposed in the cap body and electrically coupled to the speaker; wherein the playback control module includes a processing unit and a wireless communication unit coupled to the processing unit, and the wireless communication unit is capable of wirelessly receiving signals from a mobile device, and the processing unit is for operating the speaker according to the signals received from the wireless communication unit.

2. The wireless bottle cap speaker according to claim 1, wherein the lower portion of the cap body has a first connector, the upper portion of the bottle has a second connector, and the first connector is arranged for detachable connection with the second connector.

3. The wireless bottle cap speaker according to claim 2, wherein the first connector is a female threaded connector with internal threads, the second connector is a male threaded connector with external threads.

4. The wireless bottle cap speaker according to claim 2, wherein the first connector is a male threaded connector with external threads, the second connector is a female threaded connector with internal threads.

5. The wireless bottle cap speaker according to claim 2, wherein the first connector is a female connector without internal threads, the second connector is a male connector without external threads, and the first connector is arranged for detachably connecting with the second connector in a tight fit manner.

6. The wireless bottle cap speaker according to claim 1, wherein the cap body is a waterproof cap body.

7. The wireless bottle cap speaker according to claim 1, wherein the wireless communication unit is a Bluetooth unit, a Wi-Fi unit, a Zigbee unit, a near field communication unit, a Radio Frequency unit, or combinations thereof.

8. The wireless bottle cap speaker according to claim 1, wherein the playback control module further includes an operation unit electrically coupled to the processing unit for generating a key signal to the processing unit.

9. The wireless bottle cap speaker according to claim 1, wherein the playback control module further includes a display unit electrically coupled to the processing unit for displaying the status detected by the processing unit.

10. The wireless bottle cap speaker according to claim 1, wherein the playback control module further includes a connection port and an audio port electrically coupled to the processing unit separately.

11. The wireless bottle cap speaker according to claim 10, wherein the connection port is a universal serial bus port.

12. The wireless bottle cap speaker according to claim 10, wherein the connection port is a memory card port for utilizing a memory card.

13. The wireless bottle cap speaker according to claim 1, further comprising a power module electrically coupled to the playback control module and the speaker for providing power.
